(19) United States
(12) Patent Application Publication
(10) Pub. No.: US 2013/0294418 A1
(43) Pub. Date: Nov. 7, 2013

(54) Switching Between Remote Radio Heads

(71) Applicants: Ivan Vukovic, Arlington Heights, IL (US); Shirish Nagaraj, Hoffman Estates, IL (US); David Baietto, Crystal Lake, IL (US); Igor Filipovich, Chicago, IL (US)

(72) Inventors: Ivan Vukovic, Arlington Heights, IL (US); Shirish Nagaraj, Hoffman Estates, IL (US); David Baietto, Crystal Lake, IL (US); Igor Filipovich, Chicago, IL (US)

(73) Assignee: Nokia Siemens Networks Oy

(21) Appl. No.: 13/464,146

(22) Filed: May 4, 2012

(51) Int. Cl. H04W 56/00; H04W 74/08; H04W 72/04

(52) U.S. Cl. 370/336; 370/328

(57) ABSTRACT

An exemplary embodiment in accordance with this invention provides a method of managing a set of uplink reception paths and controlling the timing of uplink transmission of a UE. The method includes selecting a dominant path from a plurality of paths based at least in part on measurements of the plurality of paths. A path describes a communication route from a mobile device to an access point via a RRH. The method also includes selecting a plurality of non-dominant serving paths from the plurality of paths based at least in part on the measurements; determining a timing window based at least in part on the dominant path; determining a TA for the mobile device based at least in part on the timing window and sending the TA to the mobile device. Apparatus and computer readable media are also described.

### TECHNICAL FIELD

The exemplary and non-limiting embodiments relate generally to wireless communication systems, methods, devices and computer programs and, more specifically, relate to switching between remote radio heads.

### BACKGROUND

This section is intended to provide a background or context. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3GPP third generation partnership project

AP access point

BS base station

BW bandwidth

CC component carrier

CoMP coordinated multipoint

CRC cyclic redundancy check

DL downlink (eNB towards UE)

eNB E-UTRAN Node B (evolved Node B)

EPC evolved packet core

E-UTRAN evolved UTRAN (LTE)

FDD frequency division duplex

HARQ hybrid automatic repeat request

HO handover

IMT-A international mobile telephony-advanced

ITU international telecommunication union

ITU-R ITU radiocommunication sector

LLR log-likelihood ratio

LTE long term evolution of UTRAN (E-UTRAN)

MAC medium access control (layer 2, L2)

MM/MME mobility management/mobility management entity

Node B base station

O&M operations and maintenance

OFDMA orthogonal frequency division multiple access

PDCCH packet downlink control channel

PDCP packet data convergence protocol

PHY physical (layer 1, L1)

PUCCH packet uplink control channel

PUSCH packet uplink shared channel

RACH random access channel

RF radio frequency

RLC radio link control

RRC radio resource control

RRH remote radio head

RRM radio resource management

SC-FDMA single carrier, frequency division multiple access

S-GW serving gateway

SINR signal to interference-plus-noise ratio

TA timing advance

UE user equipment, such as a mobile station or mobile terminal

UL uplink (UE towards eNB)

UTRAN universal terrestrial radio access network

WCDMA wideband code division multiple access

A wireless network may use multiple remote radio heads (RRHs) to receive signals. The use of multiple RRHs can increase data rates and signal quality above that for an individual RRH. Several RRHs can be used as part of the same cell and appear to a user equipment (UE) as a single antenna system. This allows the UE a greater degree of mobility as various RRH can be used at different times to listen for transmissions from the UE. Additionally, the RRHs can be positioned to reduce the impact of physical barriers (such as tunnels) on signal quality.

### SUMMARY

The below summary section is intended to be merely exemplary and non-limiting.

The foregoing and other problems are overcome, and other advantages are realized, by the use of the exemplary embodiments.

In a first aspect thereof an exemplary embodiment provides a method of managing a set of uplink reception paths and controlling the timing of uplink transmission of a UE. The method includes selecting a dominant path from a plurality of paths based at least in part on measurements of the plurality of paths. A path describes a communication route from a UE to an access point via a RRH. The method also includes selecting a plurality of non-dominant serving paths from the plurality of paths based at least in part on the measurements. The method includes determining a timing window based at least in part on the dominant path and determining a TA for the UE based at least in part on the timing window. The method also includes sending the TA to the UE.

In a further aspect thereof an exemplary embodiment provides a method of managing a set of uplink reception paths and controlling the timing of uplink transmission of a UE. The method includes receiving, at a UE, a PDCCH order. In response to the PDCCH order, the method includes sending, from the UE, an UL message on a RACH. The method also includes receiving, at the UE, a TA message.

In another aspect thereof an exemplary embodiment provides an apparatus for managing a set of uplink reception paths and controlling the timing of uplink transmission of a UE. The apparatus includes at least one processor and at least one memory storing computer program code. The at least one memory and the computer program code are configured to, with the at least one processor, cause the apparatus to perform actions. The actions include selecting a dominant path from a plurality of paths based at least in part on measurements of the plurality of paths. A path describes a communication route from a UE to an access point via a RRH. The actions also include selecting a plurality of non-dominant serving paths from the plurality of paths based at least in part on the measurements. The actions include determining a timing window based at least in part on the dominant path and determining a TA for the UE based at least in part on the timing window. The actions also include sending the TA to the UE.

In a further aspect thereof an exemplary embodiment provides an apparatus for managing a set of uplink reception paths and controlling the timing of uplink transmission of a UE. The apparatus includes at least one processor and at least one memory storing computer program code. The at least one memory and the computer program code are configured to, with the at least one processor, cause the apparatus to perform actions. The actions include receiving, at a UE, a PDCCH order. In response to the PDCCH order, the actions include sending, from the UE, an UL message on a RACH. The actions also include receiving, at the UE, a TA message.

In another aspect thereof an exemplary embodiment provides a computer readable medium for managing a set of uplink reception paths and controlling the timing of uplink transmission of a UE. The computer readable medium is tangibly encoded with a computer program executable by a processor to perform actions. The actions include selecting a dominant path from a plurality of paths based at least in part on measurements of the plurality of paths. A path describes a communication route from a UE to an access point via a RRH. The actions also include selecting a plurality of non-dominant serving paths from the plurality of paths based at least in part on the measurements. The actions include determining a timing window based at least in part on the dominant path and determining a TA for the UE based at least in part on the timing window. The actions also include sending the TA to the UE.

In a further aspect thereof an exemplary embodiment provides a computer readable medium for managing a set of uplink reception paths and controlling the timing of uplink transmission of a UE. The computer readable medium is tangibly encoded with a computer program executable by a processor to perform actions. The actions include receiving, at a UE, a PDCCH order. In response to the PDCCH order, the actions include sending, from the UE, an UL message on a RACH. The actions also include receiving, at the UE, a TA message.

In another aspect thereof an exemplary embodiment provides an apparatus of managing a set of uplink reception paths and controlling the timing of uplink transmission of a UE. The apparatus includes means for selecting a dominant path from a plurality of paths based at least in part on measurements of the plurality of paths. A path describes a communication route from a UE to an access point via a RRH. The apparatus also includes means for selecting a plurality of non-dominant serving paths from the plurality of paths based at least in part on the measurements. The apparatus includes means for determining a timing window based at least in part on the dominant path and means for determining a TA for the UE based at least in part on the timing window. The apparatus also includes means for sending the TA to the UE.

In a further aspect thereof an exemplary embodiment provides an apparatus of managing a set of uplink reception paths and controlling the timing of uplink transmission of a UE. The apparatus includes means for receiving, at a UE, a PDCCH order. In response to the PDCCH order, the apparatus includes means for sending, from the UE, an UL message on a RACH. The apparatus also includes means for receiving, at the UE, a TA message.

### BRIEF DESCRIPTION OF THE DRAWINGS

The foregoing and other aspects of exemplary embodiments are made more evident in the following Detailed Description, when read in conjunction with the attached Drawing Figures, wherein:

FIG. 1 shows a simplified block diagram of exemplary electronic devices that are suitable for use in practicing various exemplary embodiments.

FIG. 2 illustrates a simplified wireless cell suitable for use in practicing various exemplary embodiments.

FIG. 3 shows a reception timeline in accordance with an exemplary embodiment.

FIG. 4 illustrates the relationship of the UE position to various serving path/dominant path options.

FIG. 5 is a signaling diagram that illustrates the operation of an exemplary embodiment.

FIG. 6 is a logic flow diagram that illustrates the operation of an exemplary method, and a result of execution of computer program instructions embodied on a computer readable memory, in accordance with various exemplary embodiments.

FIG. 7 is another logic flow diagram that illustrates the operation of an exemplary method, and a result of execution of computer program instructions embodied on a computer readable memory, in accordance with various exemplary embodiments.

### DETAILED DESCRIPTION

As the RRHs of a cell may be distributed at different geographical locations, a UL radio frequency (RF) signal from a UE may not be detected at all receivers/RRHs with the same signal to interference-plus-noise ratio (SINR) or, due to different propagation delays from the UE to different RRHs, with a potentially large differential delay (due to the delay difference between arrival times at different RRHs). The UL signals from the UE may then be combined and decoded by a baseband unit, such as an eNB.

Thus, certain paths can be unsuitable for decoding if the delay difference relative to other paths is too large or the signal quality is too poor. Since UL signals from the UE may be received at multiple RRHs, it may be tempting to combine all the usable received signals in order to better receive/decode the UL signal. However, by carefully selecting a subset of the RRH (for example, based on those which the highest SINR values) to use, the signals received by the subset of RRH may be combined to produce improved results.

In order to make the selection decision, a signal quality estimate is used for each RRH as well as timing estimate for the UE on that RRH. The baseband unit may maintain a separate observation window for each path when operating moderately large cells. Accordingly, the receiver can determine when certain antennas or paths are not to be used for received signal processing due to a low SINR and/or when the signal is received outside of an observation window.

Various exemplary embodiments solve the problem of determining timing delay from the UE to each RRH and perform timing advance calculations. Additionally, some exemplary embodiments provide techniques to control the timing of the transmission of the UE so as to allow a suitable set of paths to be usable for reception/decoding.

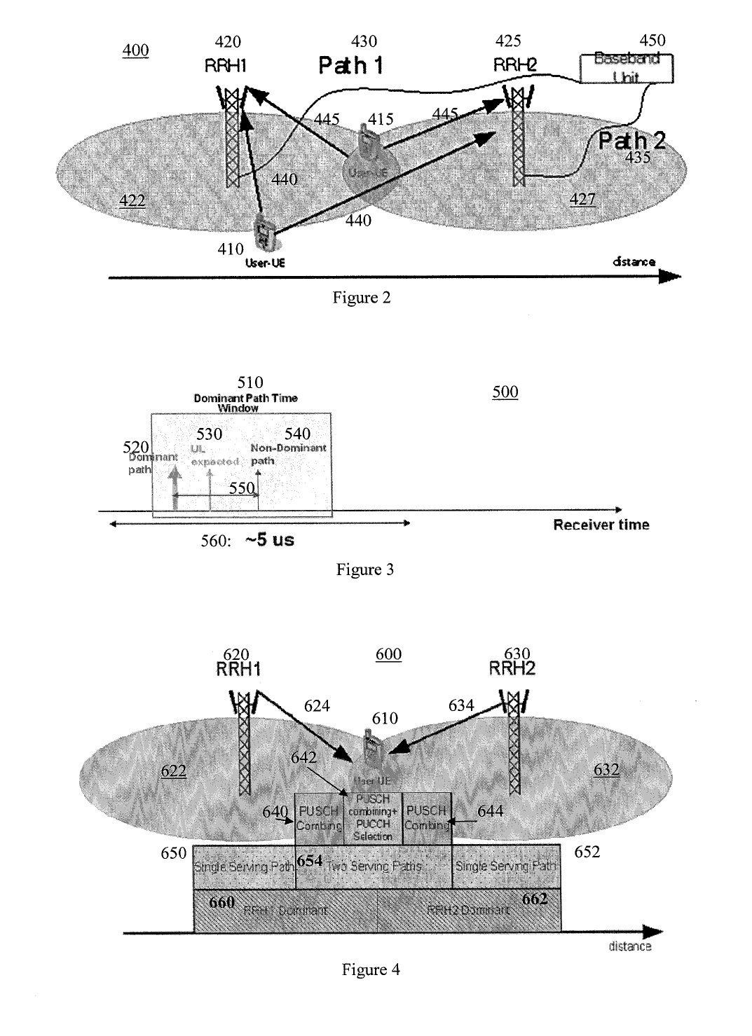

FIG. 2 illustrates a simplified wireless cell suitable for use in practicing various exemplary embodiments. The wireless cell 400 is controlled by baseband unit 450 (for example, an eNB). Within the cell are at least two RRH: RRH1 420 and RRH2 425. Additional RRHs may be included in the cell (not shown). Each RRH has a coverage area which may (or may not) overlap with a coverage area of another RRH, for example, RRH1 420 has a first coverage area 422 which overlaps a second coverage area 427 of RRH2 425.

Two UE are shown for illustration: UE 410 and UE 415. UE 415 is located midway between RRH1 420 and RRH 425 and UE 410 is located closer to RRH1 420 than to RRH 425. Accordingly, a signal 445 from UE 415 has approximately the same distance to travel in order to be detected at RRH1 420 and RRH2 425 and, thus, would be detected at approximately the same time. In contrast, a signal 440 from UE 410 has less distance to travel in order to be detected at RRH1 420 than to be detected at RRH2 425. Therefore, the signal 440 would be received first at RRH1 420 and then, after a given delay, at RRH2 425.

Once a signal 440, 445 is received at RRH1 420, it is provided to the baseband unit 450 via path 1 (430). Similarly, when a signal 440, 445 is received at RRH2 425, it is provided to the baseband unit 450 via path 2 (435). The baseband unit 450 may process/decode the signals 440, 445.

Each RRH may use a different path 430, 435 to provide information to the baseband unit 450. Additionally, there may be path-specific backhaul delays which affect the reception time of UL messages at the baseband unit 450. The baseband unit 450 may eliminate these delays error by managing the set of “paths” based on the SINR for the path (which would be unaffected by the delay). Alternatively, the baseband unit 450 may determine the expected backhaul delay from an RRH 420, 425 in order to automatically correct the reception time and/or the RRH 420, 425 may provide data regarding the reception time (for example, a time stamp).

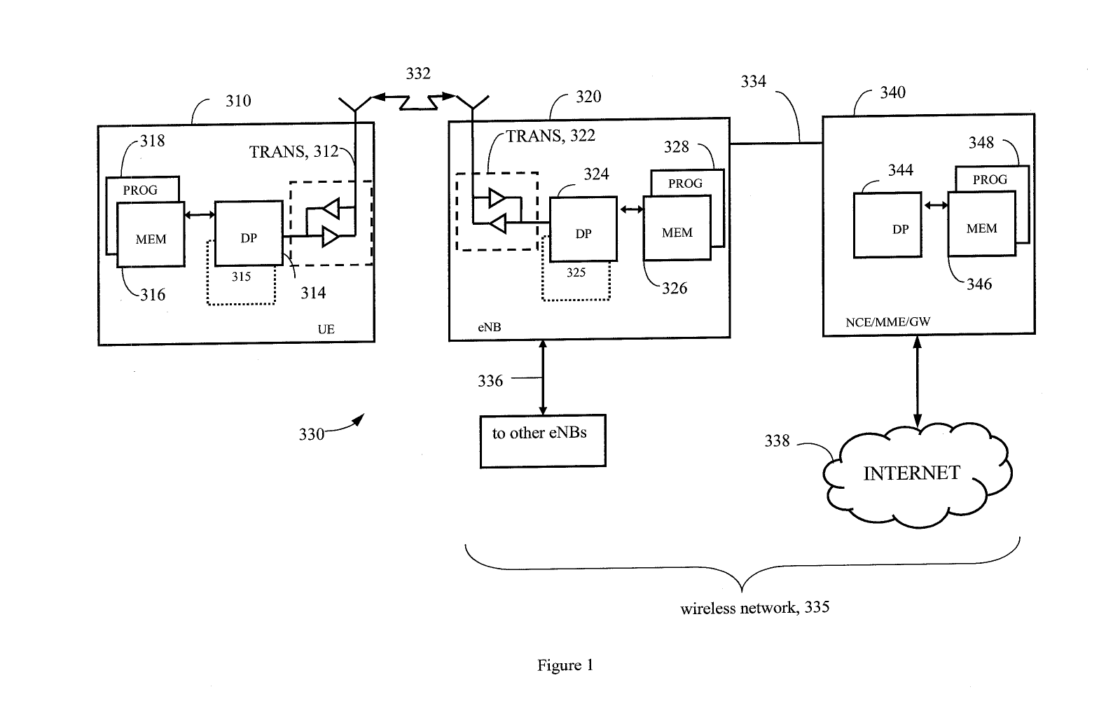

Before describing in further detail various exemplary embodiments, reference is made to FIG. 1 for illustrating a simplified block diagram of various electronic devices and apparatus that are suitable for use in practicing exemplary embodiments.

In the wireless system 330 of FIG. 1, a wireless network 335 is adapted for communication over a wireless link 332 with an apparatus, such as a mobile communication device which may be referred to as a UE 310, via a network access node, such as a Node B (base station/baseband unit), and more specifically an eNB 320. The network 335 may include a network control element (NCE) 340 that may include MME/SGW functionality, and which provides connectivity with a network, such as a telephone network and/or a data communications network (e.g., the internet 338).

The UE 310 includes a controller, such as a computer or a data processor (DP) 314, a computer-readable memory medium embodied as a memory (MEM) 316 that stores a program of computer instructions (PROG) 318, and a suitable wireless interface, such as radio frequency (RF) transceiver 312, for bidirectional wireless communications with the eNB 320 via one or more antennas (or RRH).

The eNB 320 also includes a controller, such as a computer or a data processor (DP) 324, a computer-readable memory medium embodied as a memory (MEM) 326 that stores a program of computer instructions (PROG) 328, and a suitable wireless interface, such as RF transceiver 322, for communication with the UE 310 via one or more antennas (or RRH). The eNB 320 is coupled via a data/control path 334 to the NCE 340. The path 334 may be implemented as a S1 interface. The eNB 320 may also be coupled to another eNB via data/control path 336, which may be implemented as a X2 interface.

The NCE 340 includes a controller, such as a computer or a data processor (DP) 344, a computer-readable memory medium embodied as a memory (MEM) 346 that stores a program of computer instructions (PROG) 348.

At least one of the PROGs 318, 328 and 348 is assumed to include program instructions that, when executed by the associated DP, enable the device to operate in accordance with exemplary embodiments, as will be discussed below in greater detail.

That is, various exemplary embodiments may be implemented at least in part by computer software executable by the DP 314 of the UE 310; by the DP 324 of the eNB 320; and/or by the DP 344 of the NCE 340, or by hardware, or by a combination of software and hardware (and firmware).

The UE 310 and the eNB 320 may also include dedicated processors, for example MAC selector 315 and MAC selector 325. The MAC selector 315 may be configured to detect a PDCCH order and to perform a random access channel (RACH) procedure. The MAC selector 325 may be configured to instruct the PHY which data path to use for UL processing as well as detect a trigger for sending the PDCCH order to the UE 310.

In general, the various embodiments of the UE 310 can include, but are not limited to, cellular telephones, tablets having wireless communication capabilities, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 316, 326 and 346 may be of any type suitable to the local technical environment and may be implemented using any suitable data storage technology, such as semiconductor based memory devices, flash memory, magnetic memory devices and systems, optical memory devices and systems, fixed memory and removable memory. The DPs 314, 324 and 344 may be of any type suitable to the local technical environment, and may include one or more of general purpose computers, special purpose computers, microprocessors, digital signal processors (DSPs) and processors based on a multicore processor architecture, as non-limiting examples. The wireless interfaces (e.g., RF transceivers 312 and 322) may be of any type suitable to the local technical environment and may be implemented using any suitable communication technology such as individual transmitters, receivers, transceivers or a combination of such components. Additionally, the wireless interfaces may be located within RRH which are positioned at geographically distinct locations from each other and/or the eNB 320.

The eNB/baseband unit may send a PDCCH order to request the UE to perform a RACH procedure so that the various paths from the UE to the eNB/baseband unit may be measured. The PDCCH order may be sent periodically and/or asynchronously. The period for the PDCCH may be based on network configurations and may be based on various parameters (for example, network conditions, time of day, UE speed, UE location, etc.). An asynchronous PDCCH order may be sent to the UE in response to various triggers, for example, changes in network conditions such as the dominant path SINR dropping below a given threshold (which may or may not be the same threshold to switch the dominant path).

When the PDCCH order is sent, the UE will receive a RACH response message with a timing advance (TA) and an UL grant. The UL grant provides UL resources for the UE to send an UL message. If the UE does not have an UL message to sent, the eNB/baseband unit may send a NULL grant so that the UL resources are not wasted. Note that the eNB may not release PUCCH resources for such a UE if the TA timer has not expired. The eNB/baseband unit may also instruct the RRHs to receive the expected UL message, for example, by provided an expected reception window and/or UE identification details.

Note that the PDCCH order sent by the eNB to the UE instructs the UE to transmit a random access preamble. The UE then transmits the random access preamble, and as a response to this UE transmission, the eNB sends a RACH response message.

After a UE performs an initial RACH procedure, the eNB labels a subset of all available paths as serving paths. One of the serving paths may be designated as a dominant path based on the SINR measurements of the serving paths. The available paths that are not selected as serving paths are referred to as non-serving paths. The receiver/eNB does not process these non-serving paths. However, the eNB may continually monitor the set of available paths in order to add or remove paths from the set of serving paths. A serving path is a path that will be LLR-combined for PUSCH in the UL. A non-serving path is a path that is not LLR-combined. Once a dominant path is selected, the PUCCH of the dominant path may then be selected for use with the UE.

There may be one or more serving paths (including the dominant path). All paths are processed by the PHY layer. The SINR and any timing errors are reported to the MAC layer (for example, using RACH, PUSCH, etc.). Note that, SINR and timing errors may be processed by the MAC layer for the serving paths (avoiding the excess processing to determine such data for non-serving paths). The serving paths (for example, PUSCH signals received on the serving paths) may be LLR-combined in order to provide a single combined result. The result may then be sent to the MAC layer.

The timing of the paths may be used as a criterion to add/drop serving paths and an in the selection of new dominant path. A timing window may be established which dictates which paths are available as serving paths. The window includes the dominant path, but the window need not be strictly aligned so that dominant path is at one end of the window. The position of the timing window may be chosen by other criteria depending on the paths that would lie within the window. For example, the alignment of the timing window may be determined such that the greatest number of paths and/or such that the strongest paths (such as the five strongest) are included. If a serving path falls out of timing window, that path may be dropped from the set of serving paths.

Using the dominant path, the eNB computes a timing advance for the UE. The timing advance is provided to the UE relative to the dominant path and the timing window. If the dominant path is changed, a new timing advance is provided to the UE.

Additionally, if the dominant path is lost, the UE may automatically perform another RACH procedure, so that a new timing can be estimated and a new dominant path can be selected. The UE may automatically switch to the RACH (for example, based on pre-established instructions) or the UE may wait for instructions to perform the RACH procedure.

FIG. 3 shows a timeline 500 in accordance with an exemplary embodiment. The timeline 500 indicates the time various signals are received from the UE. A timing window 510 is positioned around the expected UL reception on the dominant path 530 (which may have been selected by a baseband unit during an RACH procedure). The expected UL reception 530 represents an ideal time of a signal arrival inside the window.

As shown, the actual reception on the dominant path 520 and reception on a non-dominant path 540 are within the timing window. The reception on dominant path 520 is located near one edge of the timing window 510 and before the expected UL reception 530. The delay difference 550 indicates the time between reception on the dominant path 520 and reception on the non-dominant path 540. In a non-limiting example, the timing window 510 is less than a 5 us receiver window 560.

Furthermore, the eNB may select a new dominant path and re-compute the timing advance for the UE based on the new dominant path. When updating the dominant path/timing advance, the eNB may send a PDCCH order to request UE to perform another RACH procedure. A dominant path may be a serving path with the strongest signal quality (with a hysteresis). In some phases, the PUCCH may be processed only for the dominant path.

Accordingly, the eNB may switch the dominant path in order to perform a pseudo-handover within the cell. This allows the UE additional mobility within the cell and allows the eNB to tailor which serving paths are used in order to better decode the signals from the UE.

Various exemplary embodiments provide a mechanism to manage a set of paths based on SINR measurements for those paths. A first dominant path may be selected at the time of a RACH procedure. A new dominant path may be selected when the new path is deemed sufficiently “better” than the current dominant path. This determination may be based on SINR measurements performed during a subsequent RACH procedure. Additionally, the selection may be based on the new path being “better” for a given number of RACH procedure instances (for example, the new path being deemed “better” for at least three consecutive RACH procedures).

The subsequent RACH procedures may also be used for adding and dropping other paths from the set of serving paths (for example, the paths that are processed for decoding) based on their SINR measurements and one or more thresholds. For example, the SINR measurement may be greater than (or equal to) a first threshold in order to be added to the set of serving paths and the SINR measurement may be less than (or equal to) a second threshold in order to be dropped from the set of serving paths. The first threshold and second threshold may be set at the same value or be different, for example, the first threshold may be higher than the second threshold in order to avoid fluctuations in the set of serving paths due to minor changes in SINR measurements. The RACH procedure allows the baseband unit to identify when a new signal path that is outside of the window and not being tracked becomes a serious candidate and may warrant moving the window to include it. Note that the dominant path may be the same after the window is moved.

As seen above, when the RACH procedure is performed, a dominant path is selected. Based on the selected dominant path, non-dominant serving paths are then selected. Additionally, previous serving paths may be switched to non-serving paths based on the selected dominant path/timing window, for example, if when a previous serving path falls outside the new timing window.

The dominant path may be selected based on various criteria. As a non-limiting example, the path with the highest filtered RACH SINR and/or the highest filtered PUSCH SNR may be selected. In order to avoid ping-ponging between two dominant paths, the potential new dominant path may be requested to be larger than the existing dominant path by given amount (for example, cellCombPUSCHSinrDominantThreshDelta) and/or be larger than the existing dominant path over a plurality of RACH procedures (e.g., at least three consecutive instances or four out of the last six instances).

If the PUSCH SINR has not been measured and there is no existing dominant path (for example, at initialization or after long inactivity), the path with the highest filtered RACH SINR may be selected as the (new) dominant path. On the other hand, if the PUSCH SINR has not been measured or is invalid and there is an existing dominant path (for example, if a new serving path cannot be added due to not being in the receive window of the current dominant path), after a given number of consecutive RACHs (for example, cellCombPUSCHSinrDominantRachCount), the potential new dominant path has a higher filtered RACH SINR (for example, by cellCombPUSCHSinrDominantThreshDelta) than the existing dominant path, the potential new dominant path is added as the dominant path. The (previously) existing dominant path may then become a non-serving path if it is now outside of the timing window.

Once the dominant path is selected, additional non-dominant serving paths may then be chosen. If a non-serving path is within the dominant path timing window and the filtered PUSCH SINR is larger than a set threshold (for example, cellCombPUSCHSinrServingThreshHigh), the non-serving path may become a serving path. Otherwise, the non-serving path remains a non-serving path.

The previous serving paths may also be re-evaluated in order to determine if any should be reassigned as non-serving path. If a previous serving path is outside of the new timing window or if the previous serving path has a filtered PUSCH SINR that is below a given threshold (for example, cellCombPUSCHSinrServingThreshLow), the previous serving path becomes a non-serving path; otherwise, the previous serving path may remain a serving path.

Note that the SINR threshold for a non-serving path to become a serving path (cellCombPUSCHSinrServingThreshHigh) and the SINR threshold for a serving path to become a non-serving path (cellCombPUSCHSinrServingThreshLow) may be the same value. Alternatively, in order to avoid excess dropping and adding of serving paths, the SINR threshold for a non-serving path to become a serving path may be higher than the SINR threshold for a serving path to become a non-serving path.

A filtered PUSCH SINR may be maintained for paths within the timing window. The filtered PUSCH SINR may be based on SINR calculations over a period of time. If a path goes outside of dominant path timing window the filtered PUSCH SINR for that path is reset.

The dominant path may be determined to be lost if the filtered PUSCH SINR of the dominant path falls below a given threshold (for example, cellCombPUSCHSinrServingThreshLow) and/or CRC failures of the dominant path were reported in consecutive reports. If the PUSCH SINR is below the threshold and/or CRC failures were reported in consecutive reports, a PDCCH order is triggered. The PDCCH order requests the UE to perform a RACH procedure so that a new dominant path (as well as serving paths, a timing advance and a timing window) may be selected.

FIG. 4 illustrates the relationship of the UE 610 position to various serving path/dominant path options. As shown, the UE 610 position is illustrated on the line between RRH1 620 and RRH2 630; however, the teachings may be extended to a two dimensional problem and/or situations with more than two RRH.

The UE 610 is shown approximately equidistant from RRH1 620 and RRH2 630 and located where coverage area 622 and coverage area 632 overlap. In this location, UE 610 may receive signals 624 from RRH1 620 and signals 634 from RRH2 630, respectively. As the UE 610 moves further from the source of a signal, the SINR for that signal may decrease. Likewise, moving closer to a source is expected to increase the SINR for signals from that source. Note that interference from other sources may change this.

The UE 610 is located between a first region 660 where the dominant path is preferable through RRH1 620 and a second region 662 where the dominant path is preferable through RRH2 630. Therefore, the dominant path for the UE 610 may (potentially) be through either RRH1 620 or RRH2 630. This also places the UE 610 in region 642 where PUSCH transmissions from both RRH1 620 and RRH2 630 may be combined and PUCCH selection may be performed.

If the UE 610 moves closer to RRH1 620, the UE 610 would first transition to region 640 where PUSCH transmissions from both RRH1 620 and RRH2 630 may still be combined; however, PUCCH selection may not be necessary (as RRH1 620 is more dominant). Eventually, UE 610 may move to a point where UL transmissions received at RRH2 630 arrive outside the timing window and/or the SINR is deemed unacceptable (for example, below the threshold) and a path through RRH2 630 may be assigned as a non-serving path. This leaves the path through RRH1 620 as the only serving path (in this two RRH example). Similarly, as the UE 610 moves closer to RRH2 630, the UE will transition from PUSCH combining region 644 into single serving path region 652.

The region(s) 640, 642, 644 in which the PUSCH may be combined from different paths is larger than the region in which the PUCCH can be selected 642.

As discussed above, the timing advance may be derived from the dominant path. Additionally, the PDCCH feedback may initially be selected from the dominant path.

Traditional approaches to timing advance with multiple receiving paths may describe scenarios for Uplink CoMP systems. In these scenarios the access point (AP)/RRH may be used in order to decode UE messages if the AP/RRH satisfies a given timing relation. If the AP/RRH falls outside of a bound related to the differences in path timing and the cyclic prefix, it is to be dropped from the set used for decoding. The strict boundary conditions for AP/RRH inclusion do not provide the flexibility to position the timing window relative to the dominant path in order to better accommodate the serving cells. Likewise, the traditional approaches do not provide a method to have the timing adjusted relative to the timing window, which may be offset from the dominant path.

In one traditional approach, the timing advance communicated to the UE is computed relative to a particular type of path (such as that path that is from the AP nearest to the UE). When the timing of the nearest path changes, a new timing advance is to be determined. This is intended to allow multiple BSs to receive the transmission, and the TA communicated to the UE depends on the delays of the multiple receive paths. Thus, the traditional approaches allow the possibility that antennas/sectors can be included in the receiving set for decoding for Uplink CoMP based on SINR. For example, event-based triggers and thresholds may be established for adding/dropping paths, and deciding “best cell” and changing “best cell”. However, these approaches do not provide a RACH procedure and determination of serving paths based on the RACH procedure.

In an exemplary embodiment, one eNB is set up with two RRH (RRH1 and RRH2). Both RRH may be broadcasting the same cell ID. Note that an RRH is considered as not visible to the UE on both the DL and UL if there is zero DL and UL pathgain from the RRH.

In a given scenario, the UL timing between the UE and RRH1 is different from the UL timing between the UE and RRH2 and the DL timing between the UE and RRH1 is the same as the DL timing between the UE and RRH2. In this scenario, RRH2 is not visible to the UE.

A call may be made to connect the UE to the Cell ID (which is effectively to RRH1). As the UL pathgain between the UE and RRH2 begins to increase, the PUSCH-in-call TA commands are expected to start making the UE move towards the middle of the ideal timing of RRH1 and RRH2 as a result of the composite TA algorithm. However, in the conventional techniques, the PUSCH in-call TA does not change at all as the RRH2 UL pathgain increases. Thus, the benefits to be gained by using the RRH2 path are missed. In-between PDCCH orders and the RACH procedure, the eNB can send in-call TA commands. These TA commands may be based on both the dominant path and the other serving paths.

An exemplary embodiment provides a method of managing a set of uplink reception paths and controlling the timing of uplink transmission of a UE. The method includes determining a dominant path based on SINR measured at the RACH transmission by the UE. A timing window that includes the dominant path's arrival time is determined. The timing window boundary may be offset from the dominant path's arrival time in a manner depending on the arrival times of the other paths. The method also includes notifying the UE of a timing advance value based on the dominant path, the determined timing window, and its offset from the dominant path. A new dominant path is selected when it is sufficiently better than the old one based on RACH SINR for at least a certain number of RACH instances.

Another exemplary embodiment provides a method in wireless communication network where the first wireless node has multiple remote radio heads communicating with at least one second wireless node. The method includes detecting the dominant path at the first wireless node to at least one second wireless node and detecting the serving paths at the first wireless node to at least one second wireless node. Timing advance messages are sent based on the information from at least the dominant path. The method also includes selecting all or a subset of serving paths for processing at the first wireless node. The UE is requested to perform access procedures in order to determine access information. Based on the access information and accumulated received data information, serving paths are added or removed. The TA messages may be based on the timing information of at least one additional serving path (which may be determined as part of the access information).

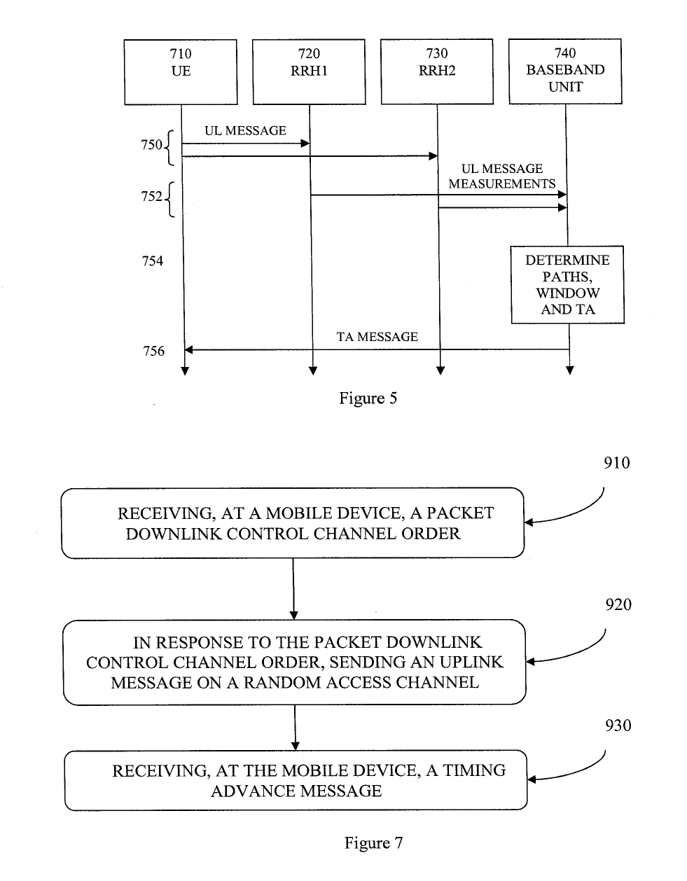

FIG. 5 is a signaling diagram that illustrates the operation of an exemplary embodiment. As shown, there is a UE 710 communicating with a baseband unit 740 through two RRH: RRH1 720 and RRH2 730. The UE 710 transmits an UL message 750 which is received by RRH1 720 and RRH2 730. While the UL message 750 is transmitted at a given time it may be received at different times at the RRH1 720 and RRH2 730. As shown, RRH1 720 receives the UL message 750 first and then the UL message is receives at RRH2 730; however, the UL message 750 may be received at RRH2 730 first or it may be received simultaneously at both RRH1 720 and RRH2 730.

The RRH1 720 and RRH2 730 may make measurements of the UL message and provide the UL message measurements 752 to the baseband unit 740. Alternatively, the RRH1 720 and RRH2 730 may simply relay the UL message to the baseband unit 740 so that the baseband unit 740 may make measurements. Furthermore, the baseband unit 740 may determine whether the link between the baseband unit 740 and an RRH 720/730 has become congested. The baseband unit 740 may consider any such congestion when selecting dominant/serving paths, for example, the baseband unit 740 may decide that a given path is to be a non-serving path based on congestion on the link from the RRH 720/730 and the baseband unit 740.

The baseband unit 740 performs a procedure 754 where the dominant path, serving path, timing window and timing advance are determined. As noted above, the dominant path and serving paths are selected based on the measurements, for example, of SINR, of a timing offset, etc. The timing window and timing advance are determined based on the set of serving paths and the dominant path. The baseband unit 740 then provides a TA message 756 to the UE 710 (for example, via coordinated multipoint transmissions from RRH1 720 and RRH2 730.

Based on the foregoing it should be apparent that various exemplary embodiments provide a method, apparatus and computer program(s) to switch between remote radio heads.

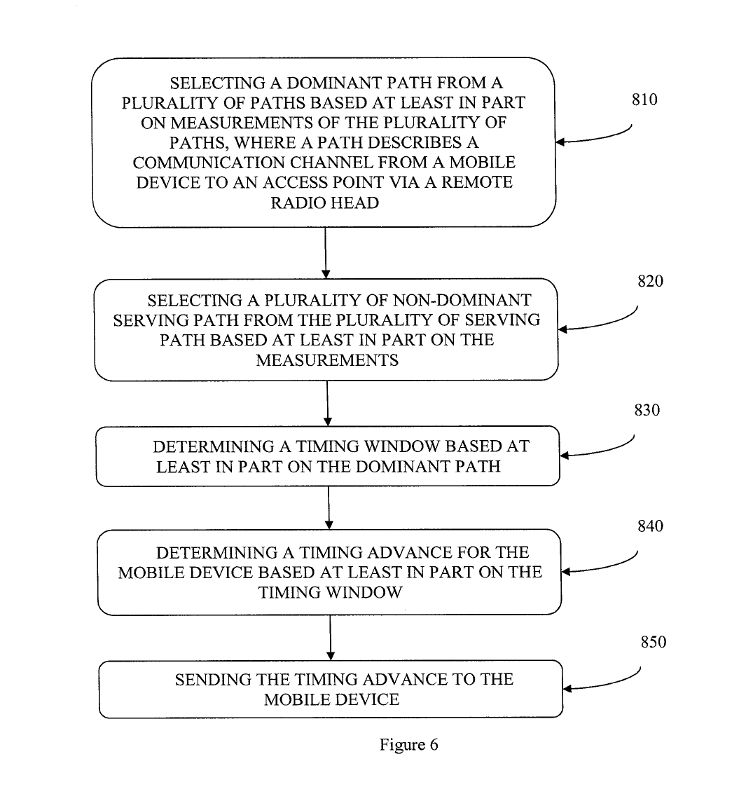

FIG. 6 is a logic flow diagram that illustrates the operation of a method, and a result of execution of computer program instructions 328, in accordance with exemplary embodiments. In accordance with these exemplary embodiments a method performs, at Block 810, a step of selecting a dominant path from a plurality of paths based at least in part on measurements of the plurality of paths. A path describes a communication channel from a mobile device (for example, a UE) to an access point (for example, an eNB) via a RRH. The method includes selecting a plurality of non-dominant serving path from the plurality of serving path based at least in part on the measurements. The method also includes determining a timing window based at least in part on the dominant path and determining a timing advance for the mobile device based at least in part on the timing window. The method includes sending the timing advance to the mobile device.

FIG. 7 is a logic flow diagram that illustrates the operation of a method, and a result of execution of computer program instructions 318, in accordance with exemplary embodiments. In accordance with these exemplary embodiments a method performs, at Block 910, a step of receiving, at a mobile device (for example, a UE), a PDCCH order. The method also includes, in response to the PDCCH order, sending an UL message on a RACH; and receiving, at the mobile device, a TA message.

The various blocks shown in FIGS. 6 and 7 may be viewed as method steps, and/or as operations that result from operation of computer program code, and/or as a plurality of coupled logic circuit elements constructed to carry out the associated function(s).

An exemplary embodiment in accordance with this invention provides a method of managing a set of uplink reception paths and controlling the timing of uplink transmission of a UE. The method includes selecting (such as by a processor) a dominant path from a plurality of paths based at least in part on measurements of the plurality of paths. A path describes a communication route from a mobile device to an access point via a RRH. The method also includes selecting (such as by a processor) a plurality of non-dominant serving paths from the plurality of paths based at least in part on the measurements. The method includes determining (such as by a processor) a timing window based at least in part on the dominant path and determining (such as by a processor) a TA for the mobile device based at least in part on the timing window. The method also includes sending (such as by a transmitter) the TA to the mobile device.

In a further exemplary embodiment of the method above, the method also includes determining an alignment of the timing window relative to the dominant path based at least in part on the plurality of non-dominant serving paths.

In another exemplary embodiment of any one of the methods above, the method also includes receiving, via a subset of paths in the plurality of paths, an UL message from the mobile device. The method may also include for each path in the subset of paths, measuring the path based on the received UL message. Measuring the path may include measuring a time of reception of the UL message at a RRH of the path. The UL message may be received on a RACH.

In a further exemplary embodiment of any one of the methods above, the measurements include a SINR and/or a timing estimate.

In another exemplary embodiment of any one of the methods above, the method also includes sending instructions to the mobile device. The instructions order the mobile device to perform a RACH procedure. The instruction may be sent on a PDCCH.

In a further exemplary embodiment of any one of the methods above, the method also includes in response to a subsequent set of measurements, determining whether to select a new dominant path. The method may also include, in response to determining to select a new dominant path: selecting a new dominant path from the plurality of paths based at least in part on the new set of measurements of the plurality of paths; determining a new timing window based at least in part on the new dominant path; determining a new TA for the mobile device based at least in part on the new timing window; and sending the new TA to the mobile device. Determining whether to select a new dominant path may include determining whether a SINR of the dominant path is below a threshold value.

In another exemplary embodiment of any one of the methods above, the method also includes, in response to a subsequent set of measurements, determining whether to remove a candidate non-dominant serving path in the plurality of non-dominant serving paths. Determining whether to remove the candidate non-dominant serving path may include determining whether a SINR of the candidate non-dominant serving path is below a threshold value and/or determining whether a reception time of an UL message using the candidate non-dominant serving path is outside the timing window.

In a further exemplary embodiment of any one of the methods above, the method also includes, in response to a subsequent set of measurements, determining whether to add paths from the plurality of paths to the plurality of non-dominant serving paths. Determining whether to add paths may include determining whether a SINR of a candidate path exceeds a threshold value.

In another exemplary embodiment of any one of the methods above, the method also includes sending, to the mobile device, an UL grant that indicates UL resources allocated for the mobile device to send an UL message.

A further exemplary embodiment in accordance with this invention provides a method of managing a set of uplink reception paths and controlling the timing of uplink transmission of a UE. The method includes receiving (such as by a receiver), at a mobile device, a PDCCH order. In response to the PDCCH order, the method includes sending (such as by a transmitter), from the mobile device, an UL message on a RACH. The method also includes receiving (such as by a receiver), at the mobile device, a TA message.

In another exemplary embodiment of the method above, the method also includes receiving a RACH response message. The RACH response message includes a timing advance and/or an UL grant.

In a further exemplary embodiment of any one of the methods above, the RACH response message includes an UL grant. The UL grant indicates UL resources allocated for the mobile device to send the UL message.

In another exemplary embodiment of any one of the methods above, the method also includes, in response to determining that a dominant path has been lost, sending, from the mobile device, another UL message on the RACH.

Another exemplary embodiment in accordance with this invention provides an apparatus for managing a set of uplink reception paths and controlling the timing of uplink transmission of a UE. The apparatus includes at least one processor (for example, DP 324) and at least one memory (for example, MEM 326) storing computer program code (for example, PROG 328). The at least one memory and the computer program code are configured to, with the at least one processor, cause the apparatus to perform actions. The actions include selecting a dominant path from a plurality of paths based at least in part on measurements of the plurality of paths. A path describes a communication route from a mobile device to an access point via a RRH. The actions also include selecting a plurality of non-dominant serving paths from the plurality of paths based at least in part on the measurements. The actions include determining a timing window based at least in part on the dominant path and determining a TA for the mobile device based at least in part on the timing window. The actions also include sending the TA to the mobile device.

In a further exemplary embodiment of the apparatus above, the actions also include determining an alignment of the timing window relative to the dominant path based at least in part on the plurality of non-dominant serving paths.

In another exemplary embodiment of any one of the apparatus above, the actions also include receiving, via a subset of paths in the plurality of paths, an UL message from the mobile device. The actions may also include for each path in the subset of paths, measuring the path based on the received UL message. Measuring the path may include measuring a time of reception of the UL message at a RRH of the path. The UL message may be received on a RACH.

In a further exemplary embodiment of any one of the apparatus above, the measurements include a SINR and/or a timing estimate.

In another exemplary embodiment of any one of the apparatus above, the actions also include sending instructions to the mobile device. The instructions order the mobile device to perform a RACH procedure. The instruction may be sent on a PDCCH.

In a further exemplary embodiment of any one of the apparatus above, the actions also include in response to a subsequent set of measurements, determining whether to select a new dominant path. The actions may also include, in response to determining to select a new dominant path: selecting a new dominant path from the plurality of paths based at least in part on the new set of measurements of the plurality of paths; determining a new timing window based at least in part on the new dominant path; determining a new TA for the mobile device based at least in part on the new timing window; and sending the new TA to the mobile device. Determining whether to select a new dominant path may include determining whether a SINR of the dominant path is below a threshold value.

In another exemplary embodiment of any one of the apparatus above, the actions also include, in response to a subsequent set of measurements, determining whether to remove a candidate non-dominant serving path in the plurality of non-dominant serving paths. Determining whether to remove the candidate non-dominant serving path may include determining whether a SINR of the candidate non-dominant serving path is below a threshold value and/or determining whether a reception time of an UL message using the candidate non-dominant serving path is outside the timing window.

In a further exemplary embodiment of any one of the apparatus above, the actions also include, in response to a subsequent set of measurements, determining whether to add paths from the plurality of paths to the plurality of non-dominant serving paths. Determining whether to add paths may include determining whether a SINR of a candidate path exceeds a threshold value.

In another exemplary embodiment of any one of the apparatus above, the actions also include sending, to the mobile device, an UL grant that indicates UL resources allocated for the mobile device to send an UL message.

In a further exemplary embodiment of any one of the apparatus above, the apparatus is embodied in a mobile device.

In another exemplary embodiment of any one of the apparatus above, the apparatus is embodied in an integrated circuit.

A further exemplary embodiment in accordance with this invention provides an apparatus for managing a set of uplink reception paths and controlling the timing of uplink transmission of a UE. The apparatus includes at least one processor (for example, DP 314) and at least one memory (for example, MEM 316) storing computer program code (for example, PROG 318). The at least one memory and the computer program code are configured to, with the at least one processor, cause the apparatus to perform actions. The actions include receiving, at a mobile device, a PDCCH order. In response to the PDCCH order, the actions include sending, from the mobile device, an UL message on a RACH. The actions also include receiving, at the mobile device, a TA message.

In another exemplary embodiment of the apparatus above, the actions also include receiving a RACH response message. The RACH response message includes a timing advance and/or an UL grant.

In a further exemplary embodiment of any one of the apparatus above, the RACH response message includes an UL grant. The UL grant indicates UL resources allocated for the mobile device to send the UL message.

In another exemplary embodiment of any one of the apparatus above, the actions also include, in response to determining that a dominant path has been lost, sending, from the mobile device, another UL message on the RACH.

In another exemplary embodiment of any one of the apparatus above, the apparatus is embodied in a mobile device.

In a further exemplary embodiment of any one of the apparatus above, the apparatus is embodied in an integrated circuit.

Another exemplary embodiment in accordance with this invention provides a computer readable medium (for example, MEM 326) for managing a set of uplink reception paths and controlling the timing of uplink transmission of a UE. The computer readable medium is tangibly encoded with a computer program (for example, PROG 328) executable by a processor (for example, DP 324) to perform actions. The actions include selecting a dominant path from a plurality of paths based at least in part on measurements of the plurality of paths. A path describes a communication route from a mobile device to an access point via a RRH. The actions also include selecting a plurality of non-dominant serving paths from the plurality of paths based at least in part on the measurements. The actions include determining a timing window based at least in part on the dominant path and determining a TA for the mobile device based at least in part on the timing window. The actions also include sending the TA to the mobile device.

In a further exemplary embodiment of the computer readable medium above, the actions also include determining an alignment of the timing window relative to the dominant path based at least in part on the plurality of non-dominant serving paths.

In another exemplary embodiment of any one of the computer readable media above, the actions also include receiving, via a subset of paths in the plurality of paths, an UL message from the mobile device. The actions may also include for each path in the subset of paths, measuring the path based on the received UL message. Measuring the path may include measuring a time of reception of the UL message at a RRH of the path. The UL message may be received on a RACH.

In a further exemplary embodiment of any one of the computer readable media above, the measurements include a SINR and/or a timing estimate.

In another exemplary embodiment of any one of the computer readable media above, the actions also include sending instructions to the mobile device. The instructions order the mobile device to perform a RACH procedure. The instruction may be sent on a PDCCH.

In a further exemplary embodiment of any one of the computer readable media above, the actions also include in response to a subsequent set of measurements, determining whether to select a new dominant path. The actions may also include, in response to determining to select a new dominant path: selecting a new dominant path from the plurality of paths based at least in part on the new set of measurements of the plurality of paths; determining a new timing window based at least in part on the new dominant path; determining a new TA for the mobile device based at least in part on the new timing window; and sending the new TA to the mobile device. Determining whether to select a new dominant path may include determining whether a SINR of the dominant path is below a threshold value.

In another exemplary embodiment of any one of the computer readable media above, the actions also include, in response to a subsequent set of measurements, determining whether to remove a candidate non-dominant serving path in the plurality of non-dominant serving paths. Determining whether to remove the candidate non-dominant serving path may include determining whether a SINR of the candidate non-dominant serving path is below a threshold value and/or determining whether a reception time of an UL message using the candidate non-dominant serving path is outside the timing window.

In a further exemplary embodiment of any one of the computer readable media above, the actions also include, in response to a subsequent set of measurements, determining whether to add paths from the plurality of paths to the plurality of non-dominant serving paths. Determining whether to add paths may include determining whether a SINR of a candidate path exceeds a threshold value.

In another exemplary embodiment of any one of the computer readable media above, the actions also include sending, to the mobile device, an UL grant that indicates UL resources allocated for the mobile device to send an UL message.

In a further exemplary embodiment of any one of the computer readable media above, the computer readable medium is a storage medium.

In another exemplary embodiment of any one of the computer readable media above, the computer readable medium is a non-transitory computer readable medium (e.g., CD-ROM, RAM, flash memory, etc.).

A further exemplary embodiment in accordance with this invention provides a computer readable medium (for example, MEM 316) for managing a set of uplink reception paths and controlling the timing of uplink transmission of a UE. The computer readable medium is tangibly encoded with a computer program (for example, PROG 318) executable by a processor (for example, DP 314) to perform actions. The actions include receiving, at a mobile device, a PDCCH order. In response to the PDCCH order, the actions include sending, from the mobile device, an UL message on a RACH. The actions also include receiving, at the mobile device, a TA message.

In another exemplary embodiment of the computer readable medium above, the actions also include receiving a RACH response message. The RACH response message includes a timing advance and/or an UL grant.

In a further exemplary embodiment of any one of the computer readable media above, the RACH response message includes an UL grant. The UL grant indicates UL resources allocated for the mobile device to send the UL message.

In another exemplary embodiment of any one of the computer readable media above, the actions also include, in response to determining that a dominant path has been lost, sending, from the mobile device, another UL message on the RACH.

In another exemplary embodiment of any one of the computer readable media above, the computer readable medium is a storage medium.

In a further exemplary embodiment of any one of the computer readable media above, the computer readable medium is a non-transitory computer readable medium (e.g., CD-ROM, RAM, flash memory, etc.).

Another exemplary embodiment in accordance with this invention provides an apparatus of managing a set of uplink reception paths and controlling the timing of uplink transmission of a UE. The apparatus includes means for selecting (such as a processor) a dominant path from a plurality of paths based at least in part on measurements of the plurality of paths. A path describes a communication route from a mobile device to an access point via a RRH. The apparatus also includes means for selecting (such as a processor) a plurality of non-dominant serving paths from the plurality of paths based at least in part on the measurements. The apparatus includes means for determining (such as a processor) a timing window based at least in part on the dominant path and means for determining (such as a processor) a TA for the mobile device based at least in part on the timing window. The apparatus also includes means for sending (such as a transmitter) the TA to the mobile device.

In a further exemplary embodiment of the apparatus above, the apparatus also includes means for determining an alignment of the timing window relative to the dominant path based at least in part on the plurality of non-dominant serving paths.

In another exemplary embodiment of any one of the apparatus above, the apparatus also includes means for receiving, via a subset of paths in the plurality of paths, an UL message from the mobile device. The apparatus may also include means for measuring, for each path in the subset of paths, the path based on the received UL message. The measuring means may include means for measuring a time of reception of the UL message at a RRH of the path. The UL message may be received on a RACH.

In a further exemplary embodiment of any one of the apparatus above, the measurements include a SINR and/or a timing estimate.

In another exemplary embodiment of any one of the apparatus above, the apparatus also includes means for sending instructions to the mobile device. The instructions order the mobile device to perform a RACH procedure. The instruction may be sent on a PDCCH.

In a further exemplary embodiment of any one of the apparatus above, the apparatus also includes means for determining whether to select a new dominant path in response to a subsequent set of measurements. The apparatus may also include, in response to determining to select a new dominant path: means for selecting a new dominant path from the plurality of paths based at least in part on the new set of measurements of the plurality of paths; means for determining a new timing window based at least in part on the new dominant path; means for determining a new TA for the mobile device based at least in part on the new timing window; and means for sending the new TA to the mobile device. The determining whether to select a new dominant path means may include means for determining whether a SINR of the dominant path is below a threshold value.

In another exemplary embodiment of any one of the apparatus above, the apparatus also includes means for determining whether to remove a candidate non-dominant serving path in the plurality of non-dominant serving paths in response to a subsequent set of measurements. The determining whether to remove the candidate non-dominant serving path means may include means for determining whether a SINR of the candidate non-dominant serving path is below a threshold value and/or determining whether a reception time of an UL message using the candidate non-dominant serving path is outside the timing window.

In a further exemplary embodiment of any one of the apparatus above, the apparatus also includes means for determining whether to add paths from the plurality of paths to the plurality of non-dominant serving paths in response to a subsequent set of measurements. The determining whether to add paths means may include means for determining whether a SINR of a candidate path exceeds a threshold value.

In another exemplary embodiment of any one of the apparatus above, the apparatus also includes means for sending, to the mobile device, an UL grant that indicates UL resources allocated for the mobile device to send an UL message.

A further exemplary embodiment in accordance with this invention provides an apparatus of managing a set of uplink reception paths and controlling the timing of uplink transmission of a UE. The apparatus includes means for receiving (such as a receiver), at a mobile device, a PDCCH order. In response to the PDCCH order, the apparatus includes means for sending (such as a transmitter), from the mobile device, an UL message on a RACH. The apparatus also includes means for receiving (such as a receiver), at the mobile device, a TA message.

In another exemplary embodiment of the apparatus above, the apparatus also includes means for receiving a RACH response message. The RACH response message includes a timing advance and/or an UL grant.

In a further exemplary embodiment of any one of the apparatus above, the RACH response message includes an UL grant. The UL grant indicates UL resources allocated for the mobile device to send the UL message.

In another exemplary embodiment of any one of the apparatus above, the apparatus also includes means for sending, from the mobile device, another UL message on the RACH in response to determining that a dominant path has been lost.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although not limited thereto. While various aspects of the exemplary embodiments may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments may be practiced in various components such as integrated circuit chips and modules, and that the exemplary embodiments may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments.

Various modifications and adaptations to the foregoing exemplary embodiments may become apparent to those skilled in the relevant arts in view of the foregoing description, when read in conjunction with the accompanying drawings. However, any and all modifications will still fall within the scope of the non-limiting and exemplary embodiments.

For example, while the exemplary embodiments have been described above in the context of the E-UTRAN (UTRAN-LTE) system, it should be appreciated that the exemplary embodiments are not limited for use with only this one particular type of wireless communication system, and that they may be used to advantage in other wireless communication systems such as for example (WLAN, UTRAN, GSM as appropriate).

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters (e.g., TA timer, etc.) are not intended to be limiting in any respect, as these parameters may be identified by any suitable names. Further, the various names assigned to different channels (e.g., PDCCH, RACH, PDCCH, etc.) are not intended to be limiting in any respect, as these various channels may be identified by any suitable names.

Furthermore, some of the features of the various non-limiting and exemplary embodiments may be used to advantage without the corresponding use of other features. As such, the foregoing description should be considered as merely illustrative of the principles, teachings and exemplary embodiments, and not in limitation thereof.

What is claimed is:

1. A method comprising:
selecting a dominant path from a plurality of paths based at least in part on measurements of the plurality of paths, where at least one path from the plurality of paths describes a communication route from a mobile device to an access point via a remote radio head;
selecting a plurality of non-dominant serving paths from the plurality of paths based at least in part on the measurements;
determining a timing window based at least in part on the dominant path;
determining a timing advance for the mobile device based at least in part on the timing window; and
sending the timing advance to the mobile device.

2. The method of claim 1, further comprising determining an alignment of the timing window relative to the dominant path based at least in part on the plurality of non-dominant serving paths.

3. The method of claim 1, further comprising receiving, via a subset of paths in the plurality of paths, an uplink message from the mobile device.

4. The method of claim 3, further comprising for each path in the subset of paths, measuring the path based on the received uplink message.

5. The method of claim 3, where the uplink message is received on a random access channel.

6. The method of claim 1, further comprising sending instructions to the mobile device, where the instructions order the mobile device to perform a random access channel procedure.

7. The method of claim 6, where the instruction are sent on a packet downlink control channel.

8. The method of claim 1, further comprising in response to a subsequent set of measurements, determining whether to select a new dominant path.

9. The method of claim 8, where determining whether to select a new dominant path comprises determining whether a signal to interference-plus-noise ratio of the dominant path is below a threshold value.

10. The method of claim 1, further comprising, in response to a subsequent set of measurements, determining whether to remove a candidate non-dominant serving path in the plurality of non-dominant serving paths.

11. The method of claim 10, where determining whether to remove the candidate non-dominant serving path comprises at least one of:
determining whether a signal to interference-plus-noise ratio of the candidate non-dominant serving path is below a threshold value; and
determining whether a reception time of an uplink message using the candidate non-dominant serving path is outside the timing window.

12. The method of claim 1, further comprising, in response to a subsequent set of measurements, determining whether to add paths from the plurality of paths to the plurality of non-dominant serving paths.

13. The method of claim 12, where determining whether to add paths comprises determining whether a signal to interference-plus-noise ratio of a candidate path exceeds a threshold value.

14. The method of claim 1, further comprising sending, to the mobile device, an uplink grant that indicates uplink resources allocated for the mobile device to send an uplink message.

15. An apparatus comprising at least one processor; and at least one memory including computer program code, the at least one memory and the computer program code configured to, with the at least one processor, cause the apparatus to perform at least the following:
to select a dominant path from a plurality of paths based at least in part on measurements of the plurality of paths, where a path describes a communication route from a mobile device to an access point via a remote radio head;
to select a plurality of non-dominant serving paths from the plurality of paths based at least in part on the measurements;
to determine a timing window based at least in part on the dominant path;
to determine a timing advance for the mobile device based at least in part on the timing window; and
to send the timing advance to the mobile device.

16. The apparatus of claim 15, where the at least one memory and the computer program code are further configured to cause the apparatus to determine an alignment of the timing window relative to the dominant path based at least in part on the plurality of non-dominant serving paths.

17. A computer readable medium tangibly encoded with a computer program executable by a processor to perform actions comprising:
selecting a dominant path from a plurality of paths based at least in part on measurements of the plurality of paths, where a path describes a communication route from a mobile device to an access point via a remote radio head;
selecting a plurality of non-dominant serving paths from the plurality of paths based at least in part on the measurements;
determining a timing window based at least in part on the dominant path;
determining a timing advance for the mobile device based at least in part on the timing window; and
sending the timing advance to the mobile device.

18. The computer readable medium of claim 17, where the actions further comprise determining an alignment of the timing window relative to the dominant path based at least in part on the plurality of non-dominant serving paths.

19. An apparatus comprising:
means for selecting a dominant path from a plurality of paths based at least in part on measurements of the plurality of paths, where a path describes a communication route from a mobile device to an access point via a remote radio head;
means for selecting a plurality of non-dominant serving paths from the plurality of paths based at least in part on the measurements;
means for determining a timing window based at least in part on the dominant path;
means for determining a timing advance for the mobile device based at least in part on the timing window; and
means for sending the timing advance to the mobile device.

20. The apparatus of claim 18, further comprising means for determining an alignment of the timing window relative to the dominant path based at least in part on the plurality of non-dominant serving paths.
